(19) United States
(12) Patent Application Publication
(10) Pub. No.: US 2026/0077598 A1
(43) Pub. Date: Mar. 19, 2026

(54) INKJET RECORDING DEVICE

(71) Applicant: KYOCERA Document Solutions Inc., Osaka (JP)

(72) Inventor: Koichi IMANAKA, Osaka (JP)

(73) Assignee: KYOCERA Document Solutions Inc., Osaka (JP)

(21) Appl. No.: 19/327,740

(22) Filed: Sep. 12, 2025

(30) Foreign Application Priority Data
Sep. 18, 2024 (JP) 2024-161407

(51) Int. Cl. B41J 2/175; B41J 29/00

(52) U.S. Cl. CPC B41J 2/17596; B41J 29/00; B41P 2251/10

(57) ABSTRACT

An inkjet recording device includes a pump, an ink flow path, an on-off valve, a motor, a one-way clutch and a closing mechanism. The motor drives the pump when rotated in a first direction. The one-way clutch is coupled to the motor, and is rotated when the motor is rotated in a second direction opposite to the first direction. The closing mechanism is coupled to the one-way clutch, and closes the on-off valve in an open state as the one-way clutch is rotated so as to stop the distribution of the ink between the pump and the on-off valve.

### INCORPORATION BY REFERENCE

This application is based upon and claims the benefit of priority from the corresponding Japanese Patent Application No. 2024-161407 (filed on September 18, 2024), the entire contents of which are incorporated herein by reference.

### BACKGROUND

The present disclosure relates to inkjet recording devices.

As recording devices such as a printer and a multifunctional peripheral, inkjet recording devices which discharge an ink on a sheet-shaped recording medium such as paper to record an image are widely used because they can record high-definition images. In such an inkjet recording device, the ink is conveyed by a pump from an ink container which contains the ink to a recording head which discharges the ink on the recording medium.

### SUMMARY

An inkjet recording device according to an aspect of the present disclosure includes a pump, an ink flow path, an on-off valve, a motor, a one-way clutch and a closing mechanism. The pump coveys an ink. The ink flow path is connected to the pump, and the ink is distributed along the ink flow path. The on-off valve is provided in the ink flow path to open and close the ink flow path. The motor drives the pump when rotated in a first direction. The one-way clutch is coupled to the motor, and is rotated when the motor is rotated in a second direction opposite to the first direction. The closing mechanism is coupled to the one-way clutch, and closes the on-off valve in an open state as the one-way clutch is rotated so as to stop the distribution of the ink between the pump and the on-off valve.

### BRIEF DESCRIPTION OF THE DRAWINGS

FIG. 1 is a schematic cross-sectional front view of an inkjet recording device according to an embodiment of the present disclosure;

FIG. 2 is a plan view of an area around a recording unit in the inkjet recording device shown in FIG. 1;

FIG. 3 is an illustrative view showing the configuration of a control system and an ink supply system around the recording unit in the inkjet recording device shown in FIG. 1;

FIG. 4 is a perspective view of a pump unit shown in FIG. 3;

FIG. 5 is a perspective view when the pump unit is viewed from a side opposite to the pump unit shown in FIG. 4;

FIG. 6 is a top view of the pump unit shown in FIG. 4;

FIG. 7 is a cross-sectional bottom view of the pump unit shown in FIG. 4;

FIG. 8 is a cross-sectional side view of the pump unit shown in FIG. 4;

FIG. 9 is a perspective view of an on-off valve (in an open state) in the pump unit shown in FIG. 4;

FIG. 10 is a perspective view of the on-off valve (in a closed state) in the pump unit shown in FIG. 4;

FIG. 11 is a perspective view of the pump unit shown in FIG. 3, and shows the closed state of the on-off valve; and

FIG. 12 is a cross-sectional side view of the pump unit (where the on-off valve is in the closed state) shown in FIG. 11.

### DETAILED DESCRIPTION

An embodiment of the present disclosure will be described below with reference to drawings. The present disclosure is not limited to details described below.

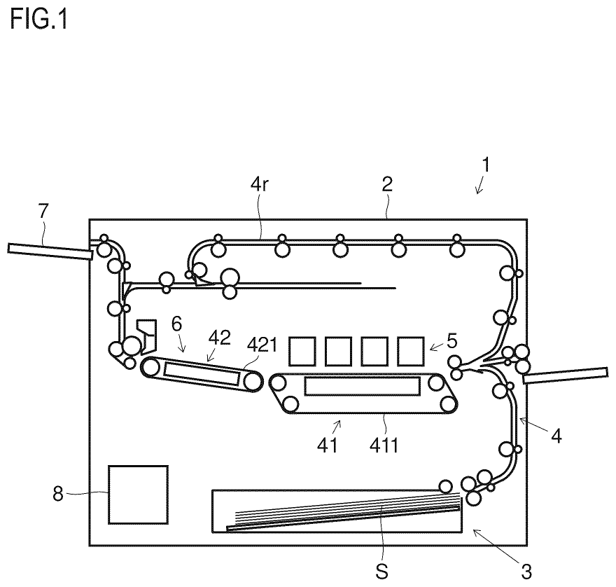

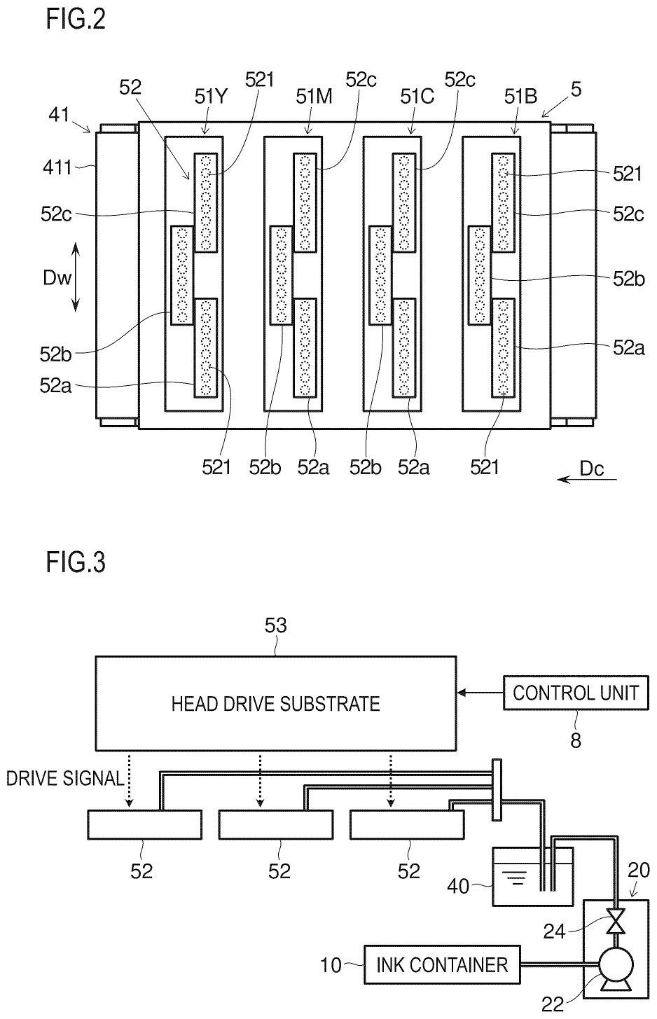

FIG. 1 is a schematic cross-sectional front view of an inkjet recording device 1 according to the embodiment. FIG. 2 is a plan view of an area around a recording unit 5 in the inkjet recording device shown in FIG. 1. The inkjet recording device 1 is, for example, an inkjet recording-type printer. As shown in FIGS. 1 and 2, the inkjet recording device 1 includes an apparatus main body 2, a sheet supply unit 3, a sheet conveyance unit 4, the recording unit 5, a drying unit 6, a sheet ejection unit 7, and a control unit 8.

For example, the sheet supply unit 3 is arranged in a lower part of the apparatus main body 2. The sheet supply unit 3 contains a plurality of sheets (recording media) S, and separates and feeds the sheets S one by one during recording.

The sheet conveyance unit 4 is arranged on a downstream side in a sheet conveyance direction with respect to the sheet supply unit 3, and conveys the sheet S fed from the sheet supply unit 3. The sheet conveyance unit 4 conveys the sheet S to the recording unit 5 and the drying unit 6, and further ejects the sheet S after recording and drying to the sheet ejection unit 7. The sheet conveyance unit 4 includes, for example, a reverse conveyance unit 4r. When double-sided recording is performed, the sheet conveyance unit 4 distributes the sheet S after the recording and drying of a first side to the reverse conveyance unit 4r, and then switches the conveyance direction to convey the sheet S which has been reversed to the recording unit 5 and the drying unit 6 again.

The sheet conveyance unit 4 includes a first belt conveyance unit 41 and a second belt conveyance unit 42. The first belt conveyance unit 41 includes a seamless first conveyance belt 411. The second belt conveyance unit 42 includes a seamless second conveyance belt 421. The first belt conveyance unit 41 and the second belt conveyance unit 42 individually suck and hold the sheet S on the outer surface (upper surface) on an upper side, and convey the sheet S. The first belt conveyance unit 41 is arranged below the recording unit 5 to convey the sheet S. The second belt conveyance unit 42 is located on the downstream side in the sheet conveyance direction with respect to the first belt conveyance unit 41, and is arranged in the drying unit 6 to convey the sheet S.

The recording unit 5 is located on the downstream side in the sheet conveyance direction with respect to the sheet supply unit 3, and is arranged opposite the first belt conveyance unit 41. The recording unit 5 is opposite the sheet S which is sucked and held on the upper surface of the first conveyance belt 411 and is conveyed, and is arranged above the first conveyance belt 411 with a predetermined distance provided therebetween. In other words, the recording unit 5 is opposite the sheet S conveyed by the sheet conveyance unit 4.

As shown in FIG. 2, the recording unit 5 holds head units 51B, 51C, 51M and 51Y which correspond to four colors of black, cyan, magenta and yellow, respectively. The head units 51B, 51C, 51M and 51Y are arranged side by side along the sheet conveyance direction Dc such that the longitudinal direction is parallel to a sheet width direction Dw orthogonal to the sheet conveyance direction Dc. Since the four head units 51B, 51C, 51M and 51Y basically have the same configuration, in the following description, unless otherwise limited, identification symbols “B”, “C”, “M” and “Y” for the colors may be omitted.

Each of the head units 51 for the colors includes a line-type inkjet recording head 52. In each of the head units 51 for the colors, a plurality of recording heads (for example, three (52a, 52b and 52c)) are arranged in a staggered configuration along the sheet width direction Dw.

The recording heads 52 include a plurality of ink discharge nozzles 521 in bottom portions thereof. The ink discharge nozzles 521 are arranged side by side along the sheet width direction Dw, and can discharge the ink over the entire recording region on the sheet S. In other words, the recording heads 52 include the ink discharge nozzles 521 which discharge the ink on the sheet S. The recording unit 5 sequentially discharges the inks from the recording heads 52 of the head units 51B, 51C, 51M and 51Y for the four colors toward the sheet S conveyed by the first conveyance belt 411, and thereby records a full-color image or a monochrome image on the sheet S.

The drying unit 6 is arranged on the downstream side in the sheet conveyance direction with respect to the recording unit 5, and includes the second belt conveyance unit 42. While the sheet S in which the ink image has been recorded in the recording unit 5 is being sucked, held and conveyed by the second conveyance belt 421 in the drying unit 6, the inks are dried. The sheet S after the drying is ejected to the sheet ejection unit 7.

The control unit 8 includes a CPU, a storage unit and other electronic circuits and electronic components (all of which are not shown). The CPU controls, based on control programs and data stored in the storage unit, the operations of constituent elements provided in the inkjet recording device 1, and thereby executes processing related to the functions of the inkjet recording device 1. The sheet supply unit 3, the sheet conveyance unit 4, the recording unit 5 and the drying unit 6 each individually receive commands from the control unit 8 to perform recording on the sheet S in conjunction with each other. The storage unit is formed with, for example, a combination of non-volatile storage devices such as a program ROM (Read Only Memory) and a data ROM and volatile storage devices such as a RAM (Random Access Memory).

Then, the configuration of an area around the recording unit 5 will be described with reference to FIG. 3. FIG. 3 is an illustrative view showing the configuration of a control system and an ink supply system around the recording unit 5 in the inkjet recording device 1 shown in FIG. 1. The inkjet recording device 1 includes an ink container 10, a pump unit 20, a sub-tank 40 and a head drive substrate 53.

The ink container 10 is provided removably with respect to the apparatus main body 2. The ink container 10 contains the ink supplied to the sub-tank 40. The ink (liquid) in the ink container 10 is conveyed via the sub-tank 40 to the recording head 52.

The pump unit 20 is arranged on a downstream side in an ink conveyance direction with respect to the ink container 10. In other words, the pump unit 20 is arranged in an ink distribution channel between the ink container 10 and the recording head 52. The pump unit 20 includes a pump 22, sucks the ink in the ink container 10 and discharges the ink toward the sub-tank 40. The operation of the pump 22 is controlled by the control unit 8. The detailed configuration of the pump unit 20 will be described later.

The sub-tank 40 stores the ink to be supplied to the recording head 52. In the sub-tank 40, an ink amount sensor (not shown) is provided. The control unit 8 controls the pump 22 to control the amount of ink supplied from the ink container 10 to the sub-tank 40 by the driving time of the pump 22. If the amount of ink in the sub-tank 40 detected by the ink amount sensor does not exceed a predetermined value even after a certain period of time has elapsed since the pump 22 was driven, the control unit 8 determines that the ink in the ink container 10 is empty. The amount of ink in the sub-tank 40 is controlled such that a water head difference between the sub-tank 40 and the recording head 52 is constant.

The head drive substrate 53 is arranged adjacent to the recording head 52, and transmits a drive signal to the recording head 52. The recording head 52 includes a drive element (not shown) for the ink discharge nozzles 521. The head drive substrate 53 transmits the drive signal having a predetermined drive waveform and a predetermined drive voltage to the drive element for the ink discharge nozzles 521. The drive waveform for the drive element for the ink discharge nozzles 521 is previously prepared according to the gradation value of the pixels (dots) of the image recorded by ink droplets which are discharged. The control unit 8 controls the head drive substrate 53 to be able to change the discharge speed of the ink to be discharged from the recording head 52. As described above, the control unit 8 controls the operation of the recording head 52 to record the image on the sheet S.

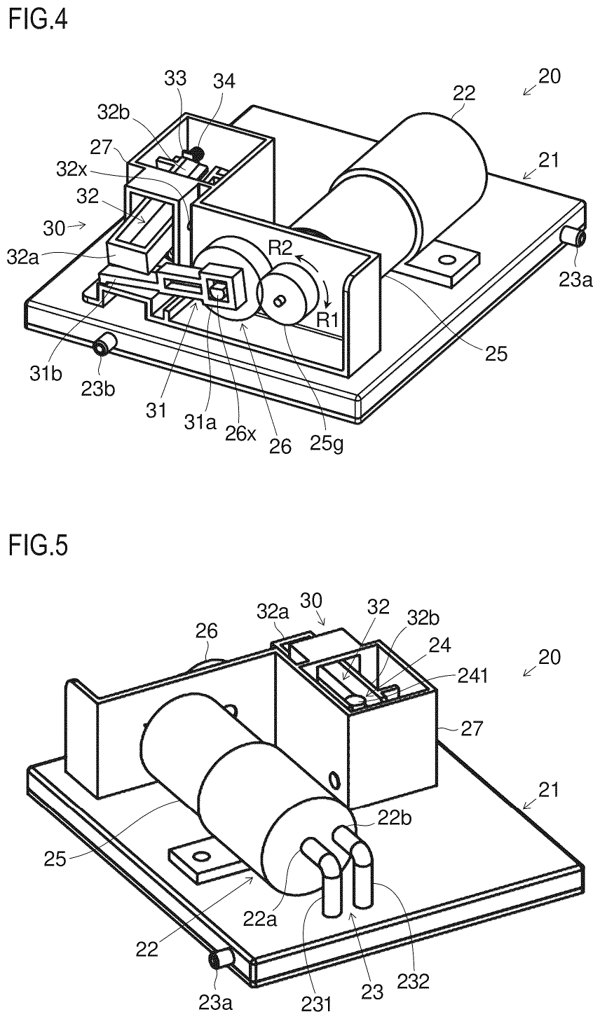

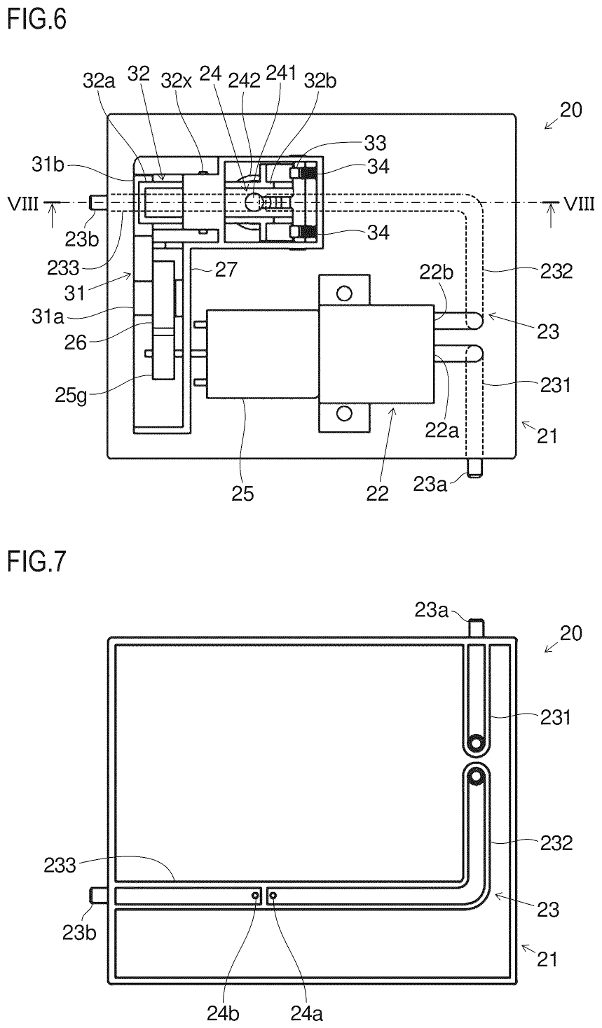

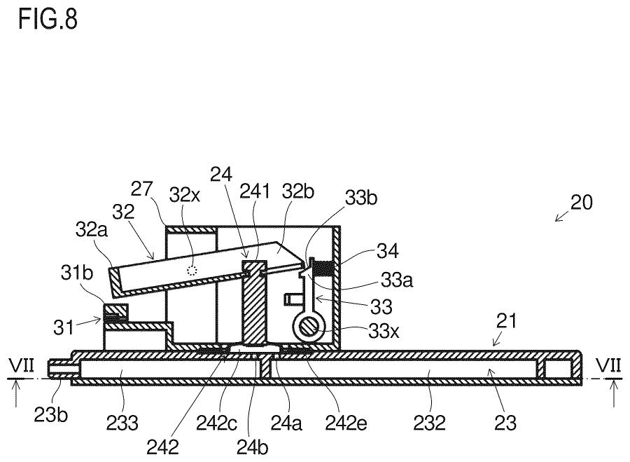

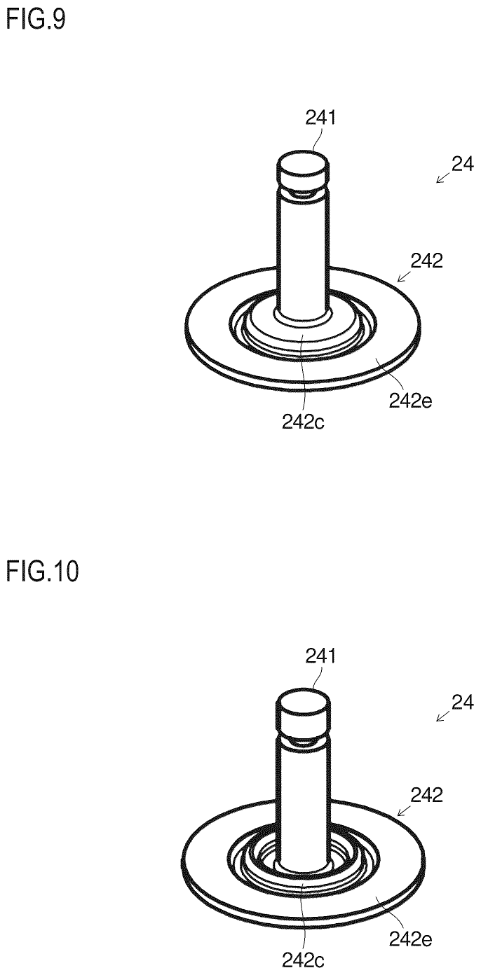

Then, the configuration of the pump unit 20 will be described. FIG. 4 is a perspective view of the pump unit 20 shown in FIG. 3. FIG. 5 is a perspective view when the pump unit 20 is viewed from a side opposite to the pump unit 20 shown in FIG. 4. FIGS. 6, 7 and 8 are respectively a top view, a cross-sectional bottom view and a cross-sectional side view of the pump unit 20 shown in FIG. 4. FIGS. 9 and 10 are a perspective view of an on-off valve 24 (in an open state) in the pump unit 20 shown in FIG. 4 and a perspective view of the on-off valve 24 (in a closed state). FIG. 7 is the cross-sectional bottom view taken along line VII-VII in FIG. 8, and FIG. 8 is the cross-sectional side view taken along line VIII-VIII in FIG. 6.

The pump unit 20 mounts, on a base member 21, the pump 22, an ink flow path 23, the on-off valve 24, a motor 25, a one-way clutch 26 and a closing mechanism 30.

The base member 21 is formed in the shape of a rectangular parallelepiped, is rectangular in plan view and is formed with a box member having a space thereinside. On the upper surface of the base member 21, the pump 22, the on-off valve 24, the motor 25, the one-way clutch 26 and the closing mechanism 30 are arranged.

A part of the ink flow path 23 is passed through the interior of the base member 21. In one side surface of the base member 21, an inlet 23a of the ink flow path 23 is provided. In another side surface intersecting the side surface in which the inlet 23a is provided, an outlet 23b of the ink flow path 23 is provided.

The pump 22 is formed with, for example, a diaphragm pump which has a diaphragm (not shown). The diaphragm pump causes the diaphragm to reciprocate using the motor 25, and conveys the ink by the reciprocation of the diaphragm. The pump 22 includes a suction unit 22a and a discharge unit 22b for the ink, and the ink flow path 23 is connected to both of them. The pump 22 conveys the ink via the ink flow path 23.

The ink flow path 23 is formed as a part of the ink distribution channel between the ink container 10 and the recording head 52. The ink flow path 23 is connected to the pump 22, and the ink is distributed along the ink flow path 23. A part of the ink flow path 23 is formed integrally with the base member 21, and the other part is formed with a piping member such as a soft tube. The ink flow path 23 includes a first flow path 231, a second flow path 232 and a third flow path 233.

The first flow path 231 extends from the inlet 23a for the ink provided in the side surface of the base member 21 to the suction unit 22a of the pump 22. In the first flow path 231, an upstream portion in the ink conveyance direction is formed integrally with the base member 21, and a downstream portion is formed with the tube. The second flow path 232 extends from the discharge unit 22b of the pump 22 to the inflow portion 24a of the on-off valve 24. In the second flow path 232, an upstream portion in the ink conveyance direction is formed with the tube, and a downstream portion is formed integrally with the base member 21. The third flow path 233 extends from the outflow portion 24b of the on-off valve 24 to the outlet 23b for the ink provided in the side surface of the base member 21. The entire third flow path 233 is formed integrally with the base member 21.

The on-off valve 24 is arranged in the ink flow path 23 between the pump 22 and the outlet 23b in the ink conveyance direction. The on-off valve 24 includes the inflow portion 24a and the outflow portion 24b which are formed in the upper surface of the base member 21. Each of the inflow portion 24a and the outflow portion 24b penetrates an upper portion of the base member 21 in a normal direction, and the inflow portion 24a and the outflow portion 24b are respectively connected to the second flow path 232 and the third flow path 233 of the ink flow path 23. The on-off valve 24 further includes a shaft portion 241 and a sealing portion 242.

The shaft portion 241 is formed in the shape of a cylinder which extends to an upper side in the normal direction with respect to the upper surface of the base member 21. The sealing portion 242 is attached to the lower end of the shaft portion 241. The upper end of the shaft portion 241 engages the closing mechanism 30. The shaft portion 241 is arranged movably in an up/down direction.

The sealing portion 242 is formed with, for example, an elastic member such as rubber, and is attached to the lower end of the shaft portion 241. The sealing portion 242 is formed substantially in the shape of a disc which extends along the upper surface of the base member 21. The sealing portion 242 is arranged adjacent to and opposite the upper surface of the base member 21 so as to cover the inflow portion 24a and the outflow portion 24b formed in the upper surface of the base member 21. A center portion 242c is opposite the inflow portion 24a and the outflow portion 24b in the up/down direction so as to cover the inflow portion 24a and the outflow portion 24b in the radial direction of the sealing portion 242 formed substantially in the shape of a disc. The outer circumferential portion 242e of the sealing portion 242 in the radial direction is constantly in intimate contact with the upper surface of the base member 21.

When the sealing portion 242 does not receive a downward load via the shaft portion 241, as shown in FIG. 9, the center portion 242c in the radial direction bulges upward, and thus as shown in FIG. 8, an internal space is formed in the center portion 242c. The inflow portion 24a and the outflow portion 24b face the internal space in the center portion 242c. In other words, when the sealing portion 242 does not receive a downward load, the ink is distributed from the inflow portion 24a to the outflow portion 24b via the internal space in the center portion 242c.

On the other hand, when the sealing portion 242 receives a downward load via the shaft portion 241, as shown in FIG. 10, the center portion 242c is recessed downward, and thus the internal space in the center portion 242c disappears (see FIG. 12). In the sealing portion 242, the center portion 242c makes intimate contact with the upper surface of the base member 21 to close the inflow portion 24a and the outflow portion 24b. In other words, when the sealing portion 242 receives a downward load, the inflow portion 24a and the outflow portion 24b are closed, and thus the distribution of the ink is blocked. In this way, the on-off valve 24 is provided in the ink flow path 23 to open and close the ink flow path 23.

The motor 25 is driven to rotate around a rotation shaft which extends substantially parallel to the upper surface of the base member 21. The motor 25 is coupled to the pump 22. The motor 25 is connected to the diaphragm of the pump 22, and causes the diaphragm to reciprocate, and thus the suction and discharge of the ink performed by the pump 22 is realized. A drive gear 25g is attached to an end of the shaft portion of the motor 25. The drive gear 25g meshes with the one-way clutch 26.

The motor 25 rotates, as shown in FIG. 4, the drive gear 25g in a first direction R1 and a second direction R2 opposite to the first direction R1. When the motor 25 is rotated in the first direction R1, the motor 25 drives the pump 22.

The one-way clutch 26 meshes with the drive gear 25g of the motor 25. The one-way clutch 26 has a mechanism in which when the motor 25 is rotated in the second direction R2, power is transmitted, and thus the one-way clutch 26 is rotated whereas when the motor 25 is rotated in the first direction R1, the one-way clutch 26 idles. In other words, the one-way clutch 26 is coupled to the motor 25, and when the motor 25 is rotated in the second direction R2 opposite to the first direction R1, the one-way clutch 26 is rotated.

The closing mechanism 30 is coupled to the one-way clutch 26. The closing mechanism 30 includes a first lever member 31 and a second lever member 32. One end portions of the first lever member 31 and the second lever member 32 in the longitudinal direction engage each other. The other end portion of the first lever member 31 is coupled to the one-way clutch 26. The other end portion of the second lever member 32 engages the on-off valve 24. The detailed configuration of the closing mechanism 30 will be described later.

The closing mechanism 30 closes the on-off valve 24 in the open state via the first lever member 31 and the second lever member 32 as the one-way clutch 26 is rotated so as to stop the distribution of the ink between the pump 22 and the on-off valve 24.

In the configuration described above, when the pump 22 is removed from the ink distribution channel from the ink container 10 to the sub-tank 40, the motor 25 is rotated in the second direction R2, and thus the on-off valve 24 is closed. In this way, it is possible to stop the distribution of the ink between the pump 22 and the on-off valve 24, and thus it is possible to suppress the leakage of the ink left in the pump 22 and the ink left in the ink flow path 23 between the pump 22 and the on-off valve 24. In other words, it is possible to enhance ease of maintenance of the inkjet recording device 1.

In a normal operation mode in which the image is recorded on the sheet S, the control unit 8 rotates the motor 25 in the first direction R1 shown in FIG. 4. On the other hand, in a maintenance operation mode in which the motor 25 is removed, the control unit 8 rotates the motor 25 in the second direction R2 shown in FIG. 4.

In the pump unit 20, the inlet 23a and the outlet 23b of the ink flow path 23 are connected to the ink distribution channel between the ink container 10 and the recording head 52. Then, the pump unit 20 is removable with respect to the ink distribution channel between the ink container 10 and the recording head 52.

In the configuration described above, since the pump 22, the on-off valve 24, the closing mechanism 30 and the like are collectively mounted on the pump unit 20, when the pump 22 is removed from the ink distribution channel, the on-off valve 24 is easily brought into the closed state, and thus it is possible to remove the pump 22. When the on-off valve 24 is in the closed state, the ink left around the inlet 23a and the outlet 23b of the pump unit 20 removed from the ink distribution channel does not leak to the outside due to the action of atmospheric pressure and the surface tension of the ink.

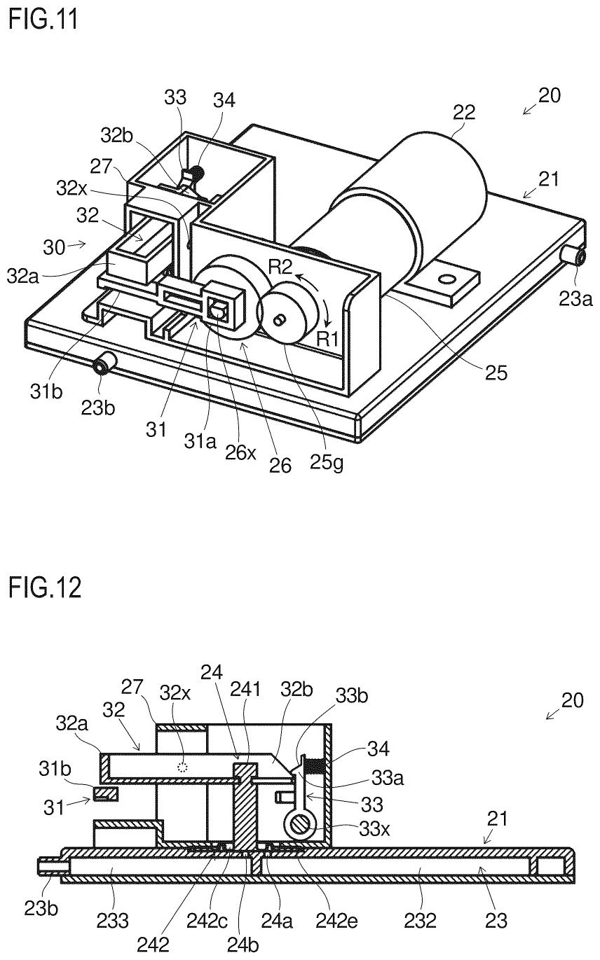

Then, the configuration of the closing mechanism 30 will be described in detail. FIG. 11 is a perspective view of the pump unit 20 shown in FIG. 3, and shows the closed state of the on-off valve 24. FIG. 12 is a cross-sectional side view of the pump unit 20 (where the on-off valve 24 is in the closed state) shown in FIG. 11. As described above, the closing mechanism 30 includes the first lever member 31 and the second lever member 32.

The first lever member 31 is connected to a shaft portion 26x of the one-way clutch 26 at a first end portion 31a in the longitudinal direction. The first lever member 31 is rotated around the center of the axis line of the shaft portion 26x according to the rotation of the one-way clutch 26 (in the second direction R2 of the motor 25).

A second end portion 31b of the first lever member 31 in the longitudinal direction is located close to a first end portion 32a of the second lever member 32 in the longitudinal direction. When the first lever member 31 is rotated around the center of the axis line of the shaft portion 26x of the one-way clutch 26, the second end portion 31b engages the first end portion 32a of the second lever member 32, and displaces the second lever member 32.

The second lever member 32 includes a support shaft portion 32x which extends substantially parallel to the upper surface of the base member 21. The support shaft portion 32x is located substantially in a center portion of the second lever member 32 in the longitudinal direction. The second lever member 32 is supported by a holder 27 provided on the upper surface of the base member 21 to be rotatable around the center of the axis line of the support shaft portion 32x. The first lever member 31 and the second lever member 32 each of which is in a longitudinal shape are arranged such that the directions of extension thereof are substantially orthogonal to each other when viewed from the normal direction of the upper surface of the base member 21.

The first end portion 32a of the second lever member 32 in the longitudinal direction is located close to the second end portion 31b of the first lever member 31 in the longitudinal direction. The second end portion 31b of the first lever member 31 makes contact with the lower surface of the first end portion 32a from below, and thus the second lever member 32 is rotated around the center of the axis line of the support shaft portion 32x.

A second end portion 32b of the second lever member 32 in the longitudinal direction engages an upper end portion of the shaft portion 241 of the on-off valve 24. When the second lever member 32 is rotated around the center of the axis line of the support shaft portion 32x, the second lever member 32 displaces the shaft portion 241 of the on-off valve 24.

In the normal operation mode in which the image is recorded on the sheet S, as shown in FIGS. 4 and 8, the first lever member 31 is not in contact with the second lever member 32. In this case, the on-off valve 24 does not receive a load from the second lever member 32, the center portion 242c of the sealing portion 242 bulges upward. In the on-off valve 24, the ink is distributed via the internal space in the center portion 242c. The side of the second end portion 32b of the second lever member 32 is displaced upward around the center of the axis line of the support shaft portion 32x.

On the other hand, when in the maintenance operation mode, the motor 25 is rotated in the second direction R2, as shown in FIGS. 11 and 12, the first lever member 31 is rotated around the center of the axis line of the shaft portion 26x of the one-way clutch 26, the first lever member 31 makes contact with the second lever member 32 from below. The second lever member 32 is rotated around the center of the axis line of the support shaft portion 32x, the side of the second end portion 32b is displaced downward. In this way, the on-off valve 24 receives a downward load from the second lever member 32, and thus the center portion 242c is recessed downward against the elastic force of the sealing portion 242, with the result that the inflow portion 24a and the outflow portion 24b are closed. The distribution of the ink is blocked in the on-off valve 24.

Although in the embodiment described above, the closing mechanism 30 includes the first lever member 31 and the second lever member 32, a configuration can be adopted in which the on-off valve 24 is arranged at the second end portion 31b of the first lever member 31 in the longitudinal direction, and thus the on-off valve 24 is closed with the single lever. In other words, the closing mechanism 30 includes at least one of the levers which are connected to the one-way clutch 26, and engage the on-off valve 24 to move the on-off valve 24 in a closing direction.

In the configuration described above, the on-off valve 24 can easily be closed by the utilization of the single motor 25 for driving the pump 22 with the simple configuration using the one-way clutch 26 and the lever members. Hence, with the simple and low-cost configuration, it is possible to enhance ease of maintenance of the inkjet recording device 1.

The closing mechanism 30 further includes a lock member 33 and a biasing member 34.

The lock member 33 is arranged on the outside of the second end portion 32b of the second lever member 32 in the longitudinal direction and adjacent to the second lever member 32. The lock member 33 is in a longitudinal shape extending in the up/down direction, and includes, at a lower end, a support shaft portion 33x which extends substantially parallel to the upper surface of the base member 21. The lock member 33 is supported by the holder 27 to be rotatable around the center of the axis line of the support shaft portion 33x.

A locking portion 33a is formed at an upper end of the lock member 33. The locking portion 33a is formed in the shape of a hook which protrudes toward the second lever member 32. As shown in FIG. 12, the second end portion 32b of the second lever member 32 is hooked on the locking portion 33a from below. In an upper portion of the locking portion 33a, an inclination surface 33b is formed such that the inclination surface 33b is inclined to approach the second lever member 32 as the inclination surface 33b extends downward.

The biasing member 34 is arranged near the upper end of the lock member 33 between the locking portion 33a and the holder 27. The biasing member 34 is formed with, for example, a compression coil spring, and biases the locking portion 33a of the lock member 33 toward the second lever member 32.

In the normal operation mode in which the image is recorded on the sheet S, as shown in FIG. 8, the second end portion 32b of the second lever member 32 is located above the lock member 33, and does not engage the lock member 33. In the on-off valve 24, the ink is distributed via the internal space in the center portion 242c.

On the other hand, when in the maintenance operation mode, the motor 25 is rotated in the second direction R2, as shown in FIG. 12, the second lever member 32 is rotated around the center of the axis line of the support shaft portion 32x, and thus the side of the second end portion 32b is displaced downward. The second end portion 32b of the second lever member 32 makes contact with the inclination surface 33b of the lock member 33, slides on the inclination surface 33b while displacing the lock member 33 clockwise in FIG. 12 against the biasing force of the biasing member 34 and moves to a lower portion of the locking portion 33a. The second end portion 32b of the second lever member 32 is hooked on the locking portion 33a, and thus the second end portion 32b is prevented from moving upward.

In this way, the lock member 33 engages the second lever member 32 to lock the on-off valve 24 into the closed state. The biasing member 34 biases the lock member 33 in a locking direction. In the configuration described above, the lock member 33 and the biasing member 34 are used to be able to hold the on-off valve 24 in the closed state. Hence, it is possible to prevent the on-off valve 24 from being displaced into an unintended open state, and thus it is possible to enhance ease of maintenance of the inkjet recording device 1.

Although the embodiment of the present disclosure has been described above, the scope of the present disclosure is not limited to the embodiment, and various changes can be made without departing from the spirit of the disclosure.

What is claimed is:

1. An inkjet recording device comprising:
a pump that coveys an ink;
an ink flow path which is connected to the pump and along which the ink is distributed;
an on-off valve that is provided in the ink flow path to open and close the ink flow path;
a motor that drives the pump when rotated in a first direction;
a one-way clutch that is coupled to the motor, and is rotated when the motor is rotated in a second direction opposite to the first direction; and
a closing mechanism that is coupled to the one-way clutch, and closes the on-off valve in an open state as the one-way clutch is rotated so as to stop the distribution of the ink between the pump and the on-off valve.

2. The inkjet recording device according to claim 1 comprising:
a pump unit that includes the pump, the ink flow path, the on-off valve, the motor, the one-way clutch and the closing mechanism,
wherein the pump unit
is arranged in an ink distribution channel between an ink container that contains the ink and a recording head that discharges the ink on a recording medium, and
is removable with respect to the ink distribution channel.

3. The inkjet recording device according to claim 1,
wherein the closing mechanism includes at least one of lever members that are connected to the one-way clutch, and engage the on-off valve to move the on-off valve in a closing direction.

4. The inkjet recording device according to claim 3,
wherein the closing mechanism includes:
a lock member that engages any one of the lever members to lock the on-off valve into a closed state when the motor is rotated in the second direction; and
a biasing member that biases the lock member in a locking direction.
